(19) United States
(12) Patent Application Publication
(10) Pub. No.: US 2020/0375830 A1
(43) Pub. Date: Dec. 3, 2020

(54) BATHING CONSTRUCTION

(71) Applicant: ROBOTICS CARE AB, Västerås (SE)

(72) Inventor: Thomas RYBERG, Djursholm (SE)

(73) Assignee: ROBOTICS CARE AB, Västerås (SE)

(21) Appl. No.: 16/761,571

(22) PCT Filed: Nov. 6, 2017
(86) PCT No.: PCT/EP2017/078313

§ 371 Date: May 5, 2020

(51) Int. Cl. A61G 7/10; A47K 3/28

(52) U.S. Cl. CPC A61G 7/1003; A61G 7/1017; A61G 7/1044; A61G 2203/44; A61G 7/108; A47K 3/282; A61G 2203/12; A61G 7/1059

(57) ABSTRACT

A bathing construction (100), comprising a bathing enclosure (110) and a seat (120) for supporting a person. The seat is pivotably coupled to a pivot (130) of the bathing construction for pivoting the seat about a horizontal axis, such that the seat, upon rotation of the pivot, is movable between a retracted position of the seat within the bathing enclosure and an extended position of the seat outside the bathing enclosure. The bathing construction further comprises an actuation system (140) coupled to the pivot, wherein the actuation system is configured to rotate the pivot for a movement of the seat between the retracted position of the seat and the extended position of the seat.

### FIELD OF THE INVENTION

This invention relates to a bathing construction, in particular for the purpose of assisting an elderly, disabled, injured and/or mobility-impaired person when bathing.

### BACKGROUND OF THE INVENTION

Bathing procedures are often problematic for elderly and/or disabled persons due to several reasons. Firstly, it should be noted that bathing arrangements such as showers and bathtubs are usually designed for the non-disabled, and especially entering and exiting these arrangements may be related to severe difficulties for disabled persons. Secondly, it will be appreciated that the bathroom environment itself may be potentially dangerous, e.g. when considering that bathroom floors may be hard and slippery. Hence, taking a shower or a bath may be hazardous for elderly and/or disabled persons, and may in some cases result in physical injuries. Consequently, many people may be forced to bathe less frequently to avoid the risks related thereto. Alternatively, help must be obtained of one or more assistants in the bathroom, especially when entering or exiting the shower or bathtub. However, the assisting staff may hereby be exposed to heavy and/or awkward lifting when helping the person, and the staff may hereby also run the risk of being injured. Furthermore, the need of assistance when undressing and/or taking care of one's personal hygiene may be embarrassing and/or humiliating for the bather.

In light of the above observations, there is an increasing need for an arrangement which is able to provide a safe and convenient assistance to elderly and/or disabled persons regarding shower or bath accessibility.

US2011/0283449 describes a system and apparatus for assisting a person during entering and exiting a bathtub and shower. The system comprises a bathtub chair system having a support member having a first end coupled to the first side of the bathtub, extending across and beyond the second side of the bathtub to a base member at the second end of the support member. The system further comprises a seating surface disposed on the support member, an electric motor disposed within the base member and a drive member coupling the seating surface to the electric motor.

However, the system as described does not provide a convenient access of an elderly and/or disabled person to the bathtub. Hence, alternative solutions are of interest, such that a safe and convenient assistance to elderly and/or disabled persons regarding shower or bath accessibility may be provided.

WO2016/107711 and WO2016/107712 describe bathing arrangements by which a person may be able to shower and/or bathe in a safe, reliable and convenient manner. It will be appreciated that the arrangements are configured to transport a person back and forth between a position outside the bathing enclosure and a position inside the bathing enclosure. Hence, the arrangements support the person's bathing and/or shower procedure in that they inhibit the occurrences of accidents when bathing and/or showering such as slipping and/or falling accidents. Due to the safe, reliable and convenient transportation of a person by means of the bathing arrangements, a safe bathing and/or shower procedure, especially for elderly and/or disabled persons may be provided.

However, there may be of interest to explore or investigate the possibilities of an even more improved construction of the bathing arrangements as previously described. More specifically, there may be a wish to provide a construction which may be even further improved compared to the prior art with regards to weight, stability, safety and/or strength.

### SUMMARY OF THE INVENTION

It is an object of the present invention to provide a bathing construction which is able to achieve a safe and convenient bath or shower access for a person, while at the same time having an advantageous structure with respect to stability, safety and/or strength.

This and other objects are achieved by providing a bathing construction having the features defined in the independent claim. Preferred embodiments are defined in the dependent claims.

Hence, according to the present invention, there is provided a bathing construction comprising a bathing enclosure. The bathing construction further comprises a seat for supporting a person. The seat is pivotably coupled to a pivot of the bathing construction for pivoting the seat about a horizontal axis, such that the seat, upon rotation of the pivot, is movable between a retracted position of the seat within the bathing enclosure and an extended position of the seat outside the bathing enclosure. The bathing construction further comprises an actuation system which is coupled to the pivot, wherein the actuation system is configured to rotate the pivot for a movement of the seat between the retracted position of the seat and the extended position of the seat.

The bathing construction according to the present invention provides a safe and conveniently accessible arrangement for showering, bathing and/or washing a person, and is particularly suitable for elderly and/or disabled persons. Furthermore, the structure of the bathing construction ensures strength and stability, whilst being relatively light.

The seat of the bathing construction is movable, by means of the actuation system via the pivot, between a first, retracted position of the seat within the bathing enclosure and a second, extended position outside the bathing enclosure. In the retracted position of the seat within the bathing enclosure, the person may be showered, bathed and/or washed. In the extended position of the seat outside the bathing enclosure, the person may sit up on the seat before his/her showering and/or bathing or leave the seat after the showering and/or bathing. The bathing construction is hereby configured to provide a convenient access of a person to the seat before his/her showering and/or bathing procedure, and analogously, a convenient leaving of the seat of the person after said procedure. The bathing construction is furthermore configured to gently and conveniently transport the person from a position outside the bathing enclosure into the bathing enclosure, where the showering and/or bathing procedure takes place. After said procedure, the bathing construction is configured to gently and conveniently transport the person back into the position outside the bathing enclosure.

The seat is pivotably coupled to a pivot of the bathing construction for pivoting the seat about a horizontal axis, and the actuation system is mechanically coupled to the pivot for rotating the pivot. The seat is hereby configured to move between its retracted and extended positions upon rotation of the pivot by the actuation system.

The present invention is advantageous in that the bathing construction provides a relatively strong and stable construction for transporting a person into, and out of, the bathing construction. It will be appreciated that the strength and stability of the bathing construction of the present invention is particularly important and advantageous for transporting elderly and/or disabled persons. Furthermore, the strength and stability of the bathing construction may ensure a safe and reliable bathing operation even for relatively large and heavy persons.

The present invention is further advantageous that a person may be able to shower and/or bathe in a safe, reliable and convenient manner. It will be appreciated that the bathing construction is configured to transport a person back and forth between a position outside the bathing enclosure and a position inside the bathing enclosure. Hence, the bathing construction supports the person's bathing and/or shower procedure in that it inhibits the occurrences of accidents when bathing and/or showering such as slipping and/or falling accidents. Due to the safe, reliable and convenient transportation of a person by means of the bathing construction, the present invention provides a safe bathing and/or shower procedure, especially for elderly and/or disabled persons.

Another advantage of the present invention is that a person may assist himself/herself when bathing and/or showering without the need of help from one or more assistants. This is understood as the bathing construction is configured to transport the person between a position outside the bathing enclosure and a position inside the bathing enclosure, and back again, wherein the bathing construction furthermore provides an easy and convenient access to the seat as well as an easy and convenient rising from the seat for the person. Hence, the bathing construction of the present invention may avoid the need of one or more assistants, which is beneficial in terms of economy and/or personal integrity.

Another advantage of a person's ability to assist himself/herself when bathing and/or showering without the need of assistant help is that the risk of injures of assistant staff may hereby be avoided. It will be appreciated the bathing construction of the present invention avoids the risk of exposing assistant staff to heavy and/or awkward lifting when helping the person, as the bathing construction provides an arrangement by which the person may bathe/shower autonomously.

It will be appreciated that the need of assistance when undressing and/or taking care of one's personal hygiene may be embarrassing and/or humiliating for the bather. Hence, another advantage of the present invention is that the bathing construction provides intimacy for the bathing person, as no personal assistance is needed for the person intending to take a bath and/or shower.

The bathing construction comprises a bathing enclosure. By the term “bathing enclosure”, it is here meant substantially any (shower) cabin, cabinet, cubicle, booth, (bath) tub, or the like.

The bathing construction further comprises a seat for supporting a person, wherein the seat is pivotably coupled to a pivot. By the term “seat”, it is here meant substantially any kind of element for supporting a person in a sitting position. By the term “pivotably coupled”, it is here meant that the seat is mechanically coupled to the pivot such that the seat may pivot or swivel along a predetermined path in a vertical plane about a horizontal axis when the pivot is rotated.

The bathing construction further comprises an actuation system coupled to the pivot. By the term “actuation system”, it is here meant substantially any system, arrangement and/or device configured, arranged and/or adapted to actuate, drive, move and/or run any element(s) coupled thereto. The actuation system is coupled to the pivot and configured, arranged and/or adapted to rotate the pivot for pivoting the seat about a horizontal axis such that the seat is moved (back and forth) between a retracted position of the seat within the bathing enclosure and an extended or extracted position of the seat outside the bathing enclosure. By the term “configured”, it is here meant that the actuation system is arranged, adapted and/or able to perform an action (e.g. a rotation of the pivot), but is not forced to do so if not needed and/or desired.

According to an embodiment of the present invention, the pivot may comprise a horizontally arranged pivot axis. The seat may hereby be pivotably coupled to the horizontally arranged pivot axis of the bathing construction for pivoting the seat about the pivot axis, such that the seat, upon rotation of the pivot axis, is movable between a retracted position of the seat within the bathing enclosure and an extended position of the seat outside the bathing enclosure.

According to an embodiment of the present invention, the actuation system comprises a lever mechanism coupled to the pivot and a telescopic element mechanically coupled to the pivot via the lever mechanism for a rotation of the pivot. By the term “lever mechanism”, it is hereby meant substantially any mechanism comprising one or more levers, mechanical arms, or the like. By the term “telescopic element”, it is here meant substantially any element which is able to become longer (extended) or shorter (retracted) upon actuation. The present embodiment is that the actuation system may conveniently actuate the telescopic element, which in turn may impart a moment on the pivot via the lever mechanism, such that the pivot may rotate.

According to an embodiment of the present invention, the bathing construction may further comprise at least one control unit communicatively coupled to the actuation system, wherein the control unit may be configured to control the movement of the seat. By the term “communicatively coupled”, it is here meant substantially any coupling and/or link (e.g. by wire or wireless) through which a communication may be established. By the term “control unit”, it is here meant substantially any unit, system, arrangement and/or device configured, arranged, adapted and/or able to control the movement, motion and/or positioning of the seat, e.g. by feedback. Hence, the control unit of the bathing construction may be configured to control the movement of the seat via the actuation system. The present embodiment is advantageous in that the bathing construction may adapt the movement of the seat according to one or more conditions, such that the bathing construction may even further facilitate the manner in which the person may sit upon the seat, be moved into (out of) the bathing enclosure and/or leave the seat, respectively.

According to an embodiment of the present invention, the at least one control unit may be manually operable. By the term “manually operable”, it is here meant that the control unit may be operable by the person using and/or intending to use the bathing construction. Alternatively, the control unit may be operable by any other person, such as an assistant. The present embodiment is advantageous in that the person using and/or intending to use the bathing construction and/or one or more assistants may control the movement of the seat.

According to an embodiment of the present invention, at least one of the at least one control unit may be arranged on the seat and may be manually operable by a person sitting on the seat. For example, the control unit may be arranged on an arm rest of the seat. The present embodiment is advantageous in that a person sitting on the seat of the bathing construction may conveniently control the movement of the seat. According to yet another embodiment of the present invention, the bathing construction may further comprise a detection unit communicatively coupled to the at least one control unit. The detection unit may be configured to detect the position of a person in relation to the seat, and the at least one control unit may be configured to position the seat according to the detected position of the person. In other words, the detection unit is configured, arranged, adapted and/or able to detect the position of a person. Based on the detected position of the person, the control unit is configured, arranged, adapted and/or able to position the seat according to the detected position. The present embodiment is advantageous in that the bathing construction, by means of the control unit, is able to position the seat relative the person to even further facilitate the manner in which the person may sit upon the seat. The present embodiment is further advantageous in that the safety of the bathing construction is increased even further, as the control unit may be configured to stop the movement of the seat in case the control unit has detected that the seat otherwise may collide with the person who intends to use the bathing construction.

According to an embodiment of the present invention, the seat may comprise at least one armrest arranged in a first horizontal direction, wherein at least one of the at least one armrest is movable between the first horizontal direction and a second direction different from the first horizontal direction. By the term “direction alongside the seat”, it is here meant a substantially horizontal direction alongside the seat. One (or both) armrests may hereby be moved away from the first direction alongside the seat into any other second direction, and back again. For example, the armrest(s) may be configured to be movable between a (horizontal) position alongside the seat and a vertical position of the armrest(s). Alternatively, the armrest(s) may be configured to be movable between a (horizontal) position alongside the seat to a position which extends laterally outward relative to the seat. It will be appreciated that the armrest(s) may be moved away when a person intends to sit upon the seat, such that the bathing construction hereby mitigates an obstruction by the armrest(s). Hence, the present embodiment is advantageous in that the bathing construction may even further facilitate the person's access to the seat and/or the manner in which the person may sit upon and/or leave the seat.

According to an embodiment of the present invention, the seat may comprise at least one weight sensor for sensing the weight of a person sitting on the seat. The at least one weight sensor may be provided, arranged and/or distributed on and/or in the seat such that the weight sensor(s) may determine the (actual) weight of a person and/or the distribution of the weight of the person on the seat. The present embodiment is advantageous in that the bathing construction may be configured to determine the position of the person on the seat. For example, the bathing construction may be configured to determine if a person sits correctly or incorrectly on the seat. The present embodiment is further advantageous in that the bathing construction may conveniently determine the weight of the person, e.g. for health registration purposes. According to yet another embodiment of the present invention, the at least one weight sensors may be communicatively coupled to the actuation system, and wherein the actuation system may be configured to move the seat as a function of the weight of a person sitting on the seat. In other words, the actuation system of the bathing construction may be configured, arranged, adapted and/or able to move the seat based on (as a function of) the weight and/or weight distribution of the person on the seat. For example, the bathing construction may be configured to determine that a person sits correctly or incorrectly on the seat, and may hereby be configured to move the seat based on this information. For example, the actuation system may be configured to move the seat if the person seems to be correctly seated on the seat and stop the movement if the person seems to be incorrectly seated on the seat. The present embodiment is advantageous in that the bathing construction is even further improved in terms of safety for the bathing person.

According to an embodiment of the present invention, the bathing enclosure may comprises a side wall being openable and closable, and wherein the actuation system is configured to open the side wall before the seat is moved from the retracted position of the seat within the bathing enclosure to the extended position of the seat outside the bathing enclosure, and to close the side wall after the seat has been moved from the extended position of the seat outside the bathing enclosure to the retracted position of the seat within the bathing enclosure. The present embodiment is advantageous in that the actuation system may be configured, arranged, adapted and/or able to (automatically) open and close the side wall dependent on the movement and/or position of the seat without the need of the person sitting on the seat to open and/or close the side wall.

According to an embodiment of the present invention, the seat is removably fastened to the bathing construction for an exchange of the seat. The present embodiment is advantageous in that the seat may be conveniently exchanged for customization purposes, in case the seat needs to be cleaned and/or in case of any damage of the seat.

According to an embodiment of the present invention, the seat comprises a foot rest which is vertically displaceable in the extended position of the seat. The present embodiment is advantageous in that the vertically displaceable foot rest may even further contribute to the accessibility and/or comfort of the seat of the bathing construction.

According to yet another embodiment of the present invention, the bathing construction of the present invention may be configured to, in the extended position of the seat, to rotate the seat in a horizontal plane and/or to tilt the seat with respect to a vertical axis. The bathing construction is hereby able to receive and to support the person in a safe and reliable way when the person intends to sit upon the seat. Analogously, the bathing construction is configured to rotate and/or tilt the seat to provide a safe and reliable operation when the person intends to leave the seat. It should be noted that the ability of the actuation system of the bathing construction to tilt the seat is particularly advantageous when the person intends to leave the seat, as the movement from an otherwise substantially horizontal position when sitting to a standing position may be particularly difficult for an elderly and/or disabled person. Furthermore, as the bathing construction is able to tilt and/or rotate the seat, the bathing construction is especially beneficial for persons who suffer from a stroke, as the mobility of their left or right side of the body may be impaired.

According to an embodiment of the present invention, there is provided a bathing arrangement comprising a bathing construction according to any one of the previous embodiments and a water supply system for a supply of water to the bathing enclosure. It will be appreciated that the water supply system may be substantially any system for supplying water to the bathing enclosure of the bathing construction. For example, the water supply system may be arranged and/or formed as a shower system, e.g. comprising one or more (shower) nozzles. Alternatively, the water supply system may be arranged and/or formed as a bath system, e.g. comprising one or more taps to at least partially fill the bathing enclosure with water. The present embodiment is advantageous in that a person sitting on the seat within the bathing enclosure may easily and conveniently take a shower and/or take a bath by means of the water supply system, wherein the water supply system may be automatically and/or manually operated.

According to an embodiment of the present invention, the bathing arrangement may comprise a product supply system for a supply of at least one body cleaning product to said bathing enclosure. It will be appreciated that the product supply system may be substantially any automatically and/or manually operated system for supplying at least one body cleaning product to the bathing enclosure. By the term “body cleaning product”, it is here meant substantially any product for the purpose of cleaning and/or washing the body, such as soap, shampoo, (hair) conditioner, etc. The present embodiment is advantageous in that the automatically and/or manually product supply system is configured and/or arranged to easily and conveniently supply at least one body cleaning product to a person sitting on the seat within the bathing enclosure.

According to an embodiment of the present invention, the bathing arrangement may comprise at least one nozzle arranged within the bathing enclosure for the purpose of cleaning a person sitting on the seat of the bathing construction. It will be appreciated that one or more nozzles may be coupled to the water supply system and/or the product supply system according to one or more the aforementioned embodiments. Furthermore, the at least one nozzle may be arranged at various positions within the bathing enclosure for cleaning different areas of the person using the bathing arrangement. The present embodiment is advantageous in that a person sitting on the seat within the bathing enclosure may be efficiently and conveniently cleaned by water and/or body cleaning product(s) at one or more areas of his/her body.

According to an embodiment of the present invention, there is provided a bathing system comprising a bathing arrangement according to any one of the previous embodiments. The bathing system further comprises a control system communicatively coupled to the water supply system and to the product supply system, wherein the control system is configured to control the supply of water and body cleaning product to the bathing enclosure. The control system may be manually or automatically operated and may furthermore be configured to control the supply of water according to a predetermined cleaning program. By the term “predetermined cleaning program”, it is here meant a program set in advance for cleaning a person sitting on the seat. For example, the program may include a water supply which is dependent on time, amount of water, position of one or more nozzles, etc. In other words, there is provided a predetermined cleaning program according to (as a function of) which the control system is configured, arranged, adapted and/or able to control the supply of water and body cleaning product from the water and the product supply systems, respectively. The present embodiment is advantageous in that a person sitting on the seat within the bathing enclosure may take a shower and/or a bath without the need of any manual intervention. Alternatively, the control system may be manually operable by the person using and/or intending to use the bathing construction, or be operable by any other person, such as an assistant, on the outside of the bathing enclosure. It will be appreciated that the control system may be communicatively coupled to and/or integrated with the control unit according to any previous embodiment.

Further objectives of, features of, and advantages with the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

This and other aspects of the present invention will now be described in more detail, with references to the appended drawings showing embodiments of the invention.

FIG. 1 shows a schematic illustration of a bathing construction according to the present invention,

FIG. 2 shows a schematic illustration of a seat of the bathing construction according to an embodiment of the present invention,

FIG. 3 shows a schematic illustration of a control unit according to an embodiment of the present invention,

FIG. 4 shows a schematic illustration of a bathing arrangement according to an embodiment of the present invention, and

FIG. 5 shows a schematic illustration of a bathing system according to an embodiment of the present invention.

All the figures are schematic, not necessarily to scale, and generally only show parts which are necessary in order to elucidate the invention, wherein other parts may be omitted or merely suggested.

### DETAILED DESCRIPTION

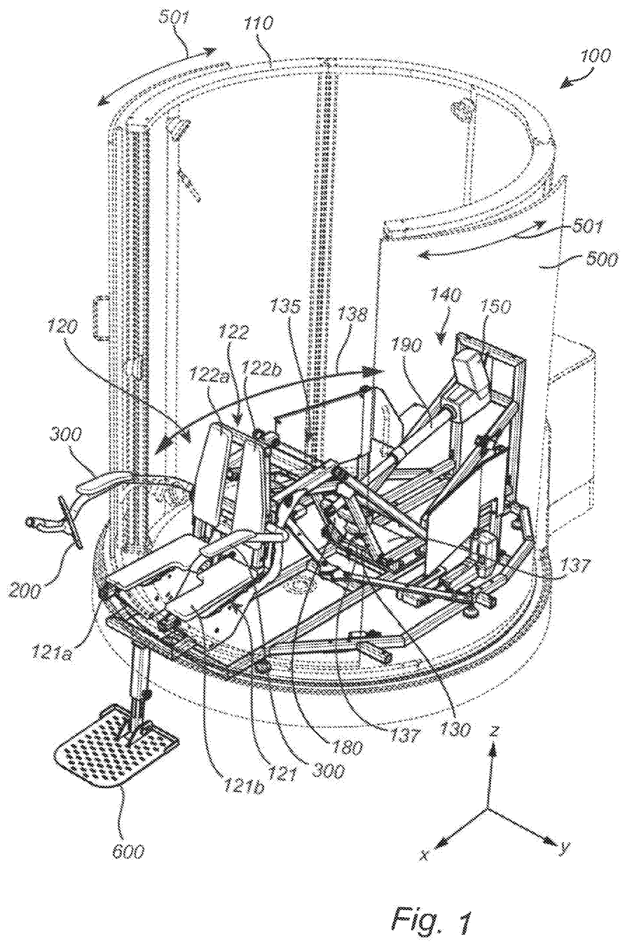

FIG. 1 shows a schematic illustration of a bathing construction 100 according to the present invention. The bathing construction 100 comprises a bathing enclosure 110. The bathing enclosure 110 in FIG. 1 is exemplified as a (shower) cabin having the shape of a cylinder with an open top. Alternatively, the bathing enclosure 110 may be a cabinet, cubicle, booth, (bath) tub, or the like. The bathing enclosure 110 may comprise an at least partially transparent material, e.g. plexiglass, glass, plastics, or the like. In case of a substantially round bathing enclosure 110, as shown in FIG. 1, the diameter of the bathing enclosure 110 may be approximately 1000-1400 mm, preferably about 1200 mm.

The bathing enclosure 110 comprises a side wall 500 being openable and closable. The side wall 500 may comprise a first portion and a second portion which may be slidingly engaged with the side wall 500, as indicated by arrows 501. Alternatively, the side wall 500 may comprise a first portion and a second portion which may be opened outwards from the side wall 500 as doors. However, the skilled person realizes that other arrangements of the side wall 500 than shown in FIG. 1 are feasible. It will be appreciated that the side wall 500 may be manually or automatically openable and closable. The side wall 500 may furthermore comprise one or more sensors for sensing if the side wall 500 is correctly closed.

The bathing construction 100 in FIG. 1 further comprises a seat 120 for supporting a person. The seat 120 comprises a seat portion 121 to support a person in the seated position, a back rest 122 arranged substantially perpendicular to the seat portion 121 and two armrests 300a,b arranged alongside the seat portion 121.

In FIG. 1, the seat portion 121 comprises two separated parts 121a,b arranged in parallel, thereby defining a space between them. The back rest 122 also comprises two parts 122a,b arranged in parallel such that a space is defined between them. The seat 120 further comprises a footrest 600 arranged below the seat portion 121. The footrest 600 may be vertically displaceable when the seat 120 is in its extended position outside the bathing enclosure. Furthermore, the footrest 600 may be configured to retract automatically to a position under the seat 120 when the seat 120 is moved into its retracted position. Analogously, the footrest 600 may be configured to extend automatically from the position under the seat 120 when the seat 120 is moved into its extended position.

The bathing construction 100 in FIG. 1 further comprises a pivot 130 to which the seat 120 is pivotably coupled for pivoting the seat about a horizontal axis. The pivot 130 as exemplified in FIG. 1 comprises or constitutes a pivot axis 130 arranged horizontally at a bottom portion of the bathing construction 100, and the seat 120 is mechanically coupled to the pivot axis 130 via a framework 135. It will be appreciated that the framework 135 of the bathing construction 100 may comprise one or more arms, levers, bars, or the like. However, for the sake of simplicity and an increased understanding of FIG. 1, the framework 135 is not described in more detail.

Upon rotation 137 of the pivot axis 130 of the bathing construction 100 in FIG. 1, the seat 120 is arranged to pivot 138 around the pivot axis 130. Consequently, the seat 120 may move along a slightly curved path in a vertical plane from the retracted position of the seat 120 to the extended position of the seat 120, and back. For example, in case of a counter-clockwise rotation 137 of the pivot axis 130, from the orientation of the bathing construction 100 as exemplified in FIG. 1, the seat 120 may pivot 138 and move from the retracted to the extended position. Analogously, in case of a clockwise rotation 137 of the pivot axis 130, the seat 120 may pivot 138 and move from the extended to the retracted position.

The bathing construction 100 further comprises a schematically indicated actuation system 140. The actuation system 140 comprises a power system 150 which in turn may comprise one or more motor arrangements, couplings, gears, etc. The power system 150 comprises a housing for sealing the components of the power system from water. It will be appreciated that further details of the power system 150 of the bathing construction 100 is omitted, since such details are well known to the skilled person.

The actuation system 140 is coupled to the pivot axis 130, and the actuation system 140 is configured to rotate the pivot axis 130 for a pivotable movement of the seat 120 between its retracted and extended positions. The actuation system 140 of the bathing construction 100 in FIG. 1 further comprises a lever mechanism 180 which is coupled to the pivot axis 130, either directly or indirectly. Moreover, a telescopic element 190 is mechanically coupled to the pivot axis 130 via the lever mechanism 180 for a rotation of the pivot axis 130.

It will be appreciated that the telescopic element 190 in FIG. 1 is linearly extendable and retractable. Hence, the telescopic element 110 is able to become longer (extended) or shorter (retracted), e.g. by sections which slide inside one another. However, it should be noted that other realizations of the telescopic element 190 may be feasible.

Hence, according to exemplifying embodiment of FIG. 1, the actuation system 140 of the bathing construction 100 is configured to rotate 137 the pivot axis 130 via the telescopic element 190. Consequently, the seat 120 may move along a predetermined and slightly curved path between a retracted position of the seat 120 within the bathing enclosure 110 and an extended position of the seat 120 outside the bathing enclosure 110. Analogously, the actuation system 140 of the bathing construction 100 is configured to move the seat 120 between the extended position of the seat 120 outside the bathing enclosure 110 to the retracted position of the seat 120 inside the bathing enclosure 110. The time for extending the telescopic element 190 from the retracted position to the extended position (or vice versa) may be approximately 30-40 seconds. Hence, the actuation system 140 is configured to extend (retract) the telescopic element 190 relatively slowly, which is beneficial for safety reasons for a person sitting on the seat 120.

According to an exemplifying embodiment of the bathing construction 100, the actuation system 140 of the bathing construction 100, in the extended position of the seat 120, may further be configured to rotate the seat 120 in a direction in a substantially horizontal plane. For example, the actuation system 140 may be configured to rotate the seat 120 approximately +90° to −90°, such as +45° to −45° in the horizontal plane x-y. Furthermore, the actuation system 140 of the bathing construction 100, in the extended position of the seat 120, may be configured to tilt the seat 120 with respect to a vertical axis. For example, the actuation system 140 may be configured to tilt the seat 120 forwards approximately 0-45°, such as 0-30°. Furthermore, the actuation system 140 may be configured to tilt the seat 120 backwards approximately 0-25°, such as 0-15°. The actuation system 140 of the bathing construction 100 may further be configured to move the seat 120, in its extended position, along the vertical axis z. In other words, the bathing construction 100 may be configured to adjust the height of the seat 120. For example, the bathing construction 100 may be configured to adjust the height of the seat portion 121 of the seat 120 to approximately 35-60 cm, such as 42-52 cm, above a floor level.

The bathing construction 100 as exemplified in FIG. 1 may further comprise a control unit 200 which is schematically indicated in FIG. 3. The control unit 200, which is communicatively coupled (by wire or wirelessly) to the actuation system 140, is configured to control the movement of the seat 120. It will be appreciated that the control unit 200 may be automatically or manually operable. The control unit 200 may be arranged on the inside of the bathing enclosure 110, such that a person 130 sitting on the seat 120 (i.e. the bathing person) may control the movement of the seat 120. For example, and as exemplified in FIG. 1, the control unit 200 may be arranged on an arm rest 300a,b of the seat 120 for a convenient control of the seat 120 by the person 130 sitting on the seat 120. Alternatively, or in combination herewith, the control unit 200 may be arranged on the outside of the bathing enclosure 110. In case of a manual operation, a person outside the bathing enclosure 110 (e.g. the bathing person or an assistant) may control the movement of the seat 120 by means of the control unit 200.

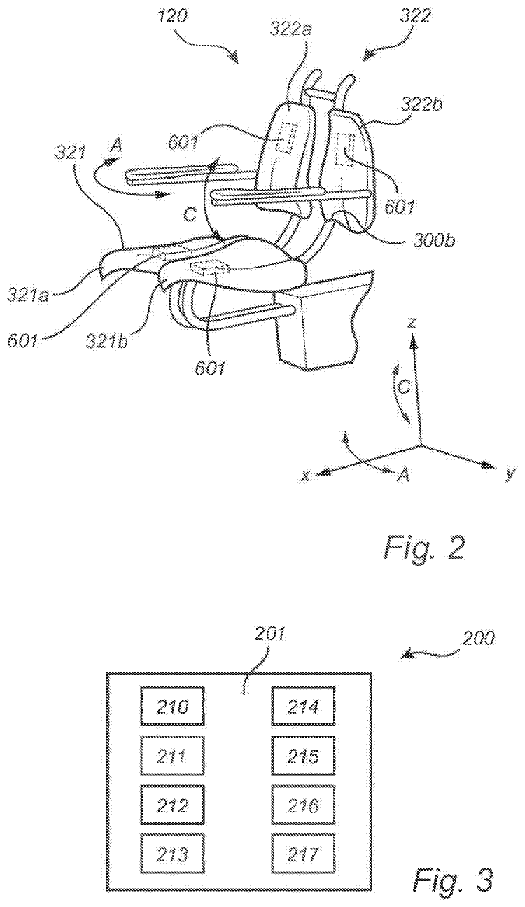

FIG. 2 shows a schematic illustration of a seat 120 of the bathing construction according to an embodiment of the present invention. It will be appreciated that the seat 120 in FIG. 3 comprises the features and components of the seat 120 in FIG. 1. The seat portion 321 comprises two cup-shaped, separated parts 321a,b arranged in parallel, thereby defining a space between them. The back rest 322 also comprises two parts 322a,b arranged in parallel such that a space is defined between them. The back seat 322 may have an arched, convex shape which bulges towards the back of a person sitting on the seat 120. The seat 120 preferably comprises a water resistant material, e.g. polyurethane, plastics or glass fiber. The seat 120 is preferably resistant to body cleaning products such as soap, shampoo, (hair) conditioner, etc., as well as surfactants, mold, cleaning agents, etc. The seat 120 is hereby configured for exposure to a warm, humid and/or wet environment and is configured to withstand fluids and/or liquid products. Furthermore, the seat 120 is preferably resistant to body excrements such as faeces, urine, sweat, etc., and the seat 120 is also easily and conveniently cleanable from such body excrements. It will be appreciated that the seat 120 as exemplified may be comprised in the bathing construction according to any previously described embodiment of the present invention. For example, the seat 120 may be removably fastened to the bathing construction for an exchange of the seat 120.

The seat 120 comprises two armrests 300a,b arranged alongside the seat 120. One (or both) armrests 300a,b may be moved and/or turned from its first (initial) horizontal direction to a second direction which is different from the first horizontal direction. For example, one or both armrest(s) 300a,b may be moved in the direction A in the horizontal x-y plane, e. g. be turned outwards from the seat 120. Furthermore, one or both armrest(s) 300a,b may be moved in the direction C with respect to the vertical axis z, i.e. be lifted or lowered upwards or downwards from the seat 120.

The seat 120 according to the exemplifying embodiment in FIG. 2 may furthermore comprises a plurality of weight sensors 601 for sensing the weight of a person sitting on the seat 120. Here, the weight sensors 601 are distributed in the seat 120 such that the weight sensors 601 furthermore may determine the distribution of the weight of the person sitting on the seat 120. It will be appreciated that the number, size and/or placement of the weight sensors 601 may vary. Furthermore, and according to an embodiment of the present invention, the weight sensors 601 may be communicatively coupled to the actuation system, and the actuation system may hereby be configured to move the seat 120 as a function of (or based on) the weight sensed by the weight sensors 601 of a person sitting on the seat 120. For example, the bathing construction may be configured to determine if a person sits correctly or incorrectly on the seat 120. In case the bathing construction determines that a person sits correctly on the seat 120 it may be configured to move the seat 120 accordingly. However, in case the bathing construction determines that a person sits incorrectly on the seat 120 it may be configured to stop the movement of the seat 120 due to safety reasons.

FIG. 3 shows a schematic illustration of a control unit 200 according to an embodiment of the present invention. The control unit 200 is exemplified as comprising a touch screen 201 indicating a plurality of touchable control areas. The touch screen 201 as exemplified comprises the touchable control areas “seat forwards” 210, “seat backwards” 211, “water on” 212, “water off” 213, etc., whereby touchable control areas 214-217 may constitute further commands related to the operation of the seat, the supply of water, alarm(s), etc. It will be appreciated that the control unit 200 may comprise more or fewer touchable control areas than those indicated above, e.g. for controlling the movement of the seat 120. Furthermore, the control unit 200 may comprise one or more knobs, or the like, for controlling the movement of the seat 120. A control of the movement of the seat 120 may be exemplified as follows: by pressing the control area “seat forwards” 210, the actuation system 140 is commanded to move the seat 120 from a retracted position of the seat 120 within the bathing enclosure 110 to an extended position of the seat 120 outside the bathing enclosure 110. Analogously, by pressing the control area “seat backwards” 211, the actuation system 140 is commanded to move the seat 120 from an extended position of the seat 120 outside the bathing enclosure 110 to a retracted position of the seat 120 inside the bathing enclosure 110.

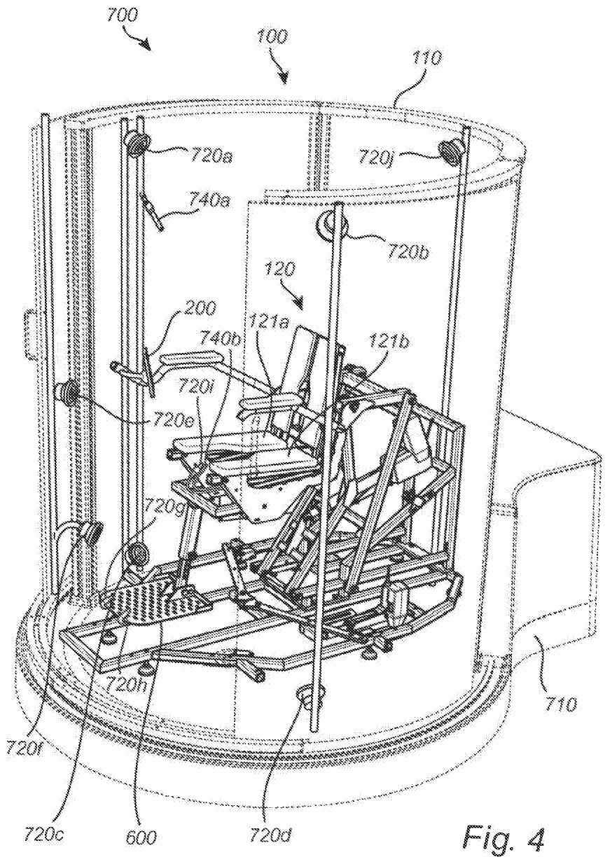

FIG. 4 shows a schematic illustration of a bathing arrangement 700 according to an embodiment of the present invention. The bathing arrangement 700 comprises a bathing construction 100 according to any one of the aforementioned embodiments. It will be appreciated that the seat 120 in the bathing construction 100 in FIG. 4 is shown in a retracted position of the seat 120 compared to the seat 120 of the bathing construction 100 in FIG. 1, which is shown in the extended position. The bathing construction 100 further comprises a schematically indicated water supply system 710 for a supply of water to the bathing enclosure 110. It will be appreciated that the bathing arrangement 700 may be constructed or designed as a shower, wherein the supplied water may flow out through a floor drain arranged in the bathing enclosure 110. Alternatively, the bathing arrangement 700 may be constructed or designed as a bath, wherein the supplied water may fill up the bathing enclosure 110 to a desired and/or predetermined water level. It will be appreciated that the water supply system 710 may comprise a water source such as a tap of a bathtub, shower, wash basin, or the like, which may be provided in the (bath) room where the bathing construction 100 is arranged. The water supply system 710 may further comprise one or more conduit(s), pump(s), etc., for a supply of water to the bathing enclosure 110. However, for the sake of simplicity, it should be noted that a more detailed description of the arrangement of the water supply system 710 is omitted.

The bathing arrangement 700 in FIG. 4 further comprises a plurality of water nozzles 720a-j which are arranged within the bathing enclosure 110. The water nozzles 720a-j are arranged to spray water on a person sitting on the seat 120 of the bathing construction 100 for the purpose of cleaning said person. In the bathing arrangement 700 as exemplified, there are ten water nozzles 720a-j arranged within the bathing enclosure 110. Water nozzles 720a and 720b are arranged on the front left and right hand side, respectively, of the bathing enclosure 110 and at relatively high positions with respect to the bathing enclosure 110 such that they are arranged to spray water obliquely downwards towards on a person sitting on the seat 120. For example, the water nozzles 720a and 720b may be arranged to spray water on the chest and/or torso of a person sitting on the seat 120. Accordingly, water nozzles 720c and 720d are arranged on the front left and right hand side, respectively, of the bathing enclosure 110 and at relatively low positions with respect to the bathing enclosure 110 such that they are arranged to spray water obliquely upwards towards on a person sitting on the seat 120. Water nozzles 720e and 720f are arranged in a vertical sequence on the front side of the bathing enclosure 110 such that they are arranged to spray water on the torso, thighs, legs and/or feet of a person sitting on the seat 120. According to an exemplifying embodiment, there may even be provided water nozzles 720g and 720h arranged on the footrest 600 of the seat 120 such that they are arranged to spray water on the foot soles of a person sitting on the seat 120. Water nozzle 720i is arranged in (or in a vicinity of) the space defined by the two separated parts 121a,b of the seat 120. Water nozzle 720i is hereby arranged to spray water obliquely upwards towards a genital, perianal and/or intergluteal area of a person sitting on the seat 120. It will be appreciated that water nozzle 720i may be of special importance for washing/cleaning the lower abdomen of women, as water from the water nozzle 720i may spray in a direction from the vaginal area towards the perianal or intergluteal area. Water nozzle 720j is arranged on the back side of the bathing enclosure 110 such that it is arranged to spray water on the back of a person sitting on the seat 120. The bathing arrangement 700 may further comprise a manually operable shower head (not shown) arranged within the bathing enclosure 110 for a convenient shower operation, if desired and/or needed, by a person sitting on the seat 120.

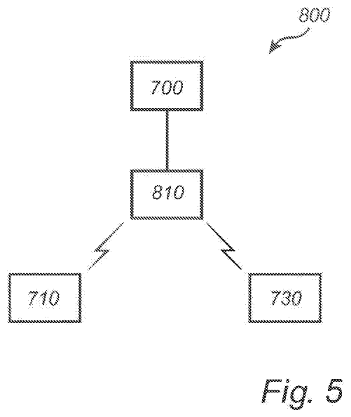

In FIG. 4, the bathing arrangement 700 may further comprise a product supply system for a supply of a body cleaning product (e.g. soap, shampoo, etc.) to the bathing enclosure 110. The product supply system, which is arranged separately from the water supply system 710, may comprises a container in which the body cleaning product is stored. The product supply system may further comprise one or more conduit(s), coupling(s), pump(s), etc., for a supply of body cleaning product to the bathing enclosure 110. The product supply system further comprises a plurality of body cleaning product nozzles 740a,b which are arranged within the bathing enclosure 110. The body cleaning product nozzles 740a,b (hereafter denoted soap nozzles 740a,b) are arranged to spray a body cleaning product (e.g. soap, shampoo, etc.) from the container on a person sitting on the seat 120 of the bathing construction 100 for the purpose of cleaning said person. In the bathing arrangement 700 as exemplified in FIG. 5, there are two soap nozzles 740a and 740b arranged within the bathing enclosure 110. Soap nozzle 740a is arranged on the front side of the bathing enclosure 110 and at a relatively high position with respect to the bathing enclosure 110 such that the soap nozzle 740a is arranged to spray a body cleaning product obliquely downwards towards on a person sitting on the seat 120. For example, the soap nozzle 740a may be arranged to spray a body cleaning product on the chest and/or torso of a person sitting on the seat 120. Soap nozzle 740b is arranged in (or in a vicinity of) the space defined by the two separated parts 121a,b of the seat 120. Soap nozzle 740b is hereby arranged to spray a body cleaning product obliquely upwards towards a genital, perianal and/or intergluteal area of a person sitting on the seat 120.

It will be appreciated that one or more of the water nozzles 720a-j and the soap nozzles 740a,b may be adjustable with respect to its angle of inclination. Furthermore, the water nozzles 720a-j and the soap nozzles 740a,b may comprise a bayonet coupling. The pressure in the water nozzles 720a-j and the soap nozzles 740a,b may, approximately, be 4-6 bar.

FIG. 5 shows a schematic illustration of a bathing system 800 according to an embodiment of the present invention. The bathing system 800 comprises a bathing arrangement 700 according to any previously described embodiment. In FIG. 5, the bathing arrangement 700 comprises both a water supply system 710 and a product supply system 730. The bathing system 800 further comprises a control system 810 which is communicatively coupled (by wire or wirelessly) to the water supply system 710 and/or to the product supply system 730. The control system 810 is hereby configured to control the supply of water and/or body cleaning product to the bathing enclosure of the bathing arrangement 700. The control system 810 may be automatic and may furthermore be configured to control the supply of water and/or body cleaning product according to a predetermined cleaning program. For example, the predetermined cleaning program may include a supply of water and/or body cleaning product wherein the amount, flow and/or temperature of the water and/or body cleaning product is set in advance. For example, the predetermined cleaning program may be formed such that a person sitting on the seat of the bathing construction of the bathing arrangement may in a first stage of the cleaning program be showered (washed, sprayed) with water by one or more of the water nozzles of the bathing arrangement. Then, in a second stage of the cleaning program, the person may accordingly be showered (washed, sprayed) with a body cleaning product (e.g. soap) by one or more of the soap nozzles of the bathing arrangement. Then, in a third stage of the cleaning program, the person may again be showered with water.

The control system 810 may alternatively be manually operable by the person using and/or intending to use the bathing construction, or be operable by any other person, such as an assistant, on the outside of the bathing enclosure. The control system 810 may for example be communicatively coupled to and/or integrated with the control unit 200 according to any previous embodiment. For example, the control system 810 may be integrated with the control unit 200 arranged on the seat 120 (e.g. on an arm rest 300a,b) for a convenient control by the person sitting on the seat 120. Hence, the control unit 200 may furthermore comprise functions of the control system 810 related to the supply of water and/or body cleaning product. For example, the touch screen 201 as previously exemplified in FIG. 3 may further comprise one or more touchable control areas (or knobs) to control the supply of the amount of, the temperature of and/or time periods of water or body cleaning product. For example, the touch screen 201 may comprise touchable control areas such as “water”, “time”, “soap”, “temperature”, etc. Alternatively, instead of touchable control areas, functions of the control system 810 related to the supply of water and/or body cleaning product may be controllable by buttons, switches, or the like.

Even though the invention has been described with reference to specific exemplifying embodiments thereof, many different alterations, modifications and the like will become apparent to those skilled in the art after studying this description. The described embodiments are therefore not intended to limit the scope of this invention. For example, the size and/or shape of one or more of the part, portions and/or elements of the bathing construction 100 such as the bathing enclosure 110, the seat 120, the telescopic element 190, etc. may be different that that shown or indicated. Furthermore, the number, positioning of one or more of the part, portions and/or elements of the bathing construction 100 such as the water nozzles 720a-j and/or the soap nozzles 720a-b may be different than that shown.

1.-15. (canceled)

16. A bathing construction, comprising
a bathing enclosure comprising a side wall being openable and closable,
a seat for supporting a person, wherein the seat is pivotably coupled to a pivot of the bathing construction for pivoting the seat about a horizontal axis, such that the seat, upon rotation of the pivot, is movable between a retracted position of the seat within the bathing enclosure and an extended position of the seat outside the bathing enclosure, and
an actuation system coupled to the pivot, wherein the actuation system is configured to rotate the pivot for a movement of the seat between the retracted position of the seat and the extended position of the seat, and wherein the actuation system is configured to open the side wall before the seat is moved from the retracted position of the seat within the bathing enclosure to the extended position of the seat outside the bathing enclosure, and to close the side wall after the seat has been moved from the extended position of the seat outside the bathing enclosure to the retracted position of the seat within the bathing enclosure.

17. The bathing construction of claim 16, wherein the pivot comprises a horizontally arranged pivot axis.

18. The bathing construction of claim 16, wherein the actuation system comprises a lever mechanism coupled to the pivot and a telescopic element mechanically coupled to the pivot via the lever mechanism for a rotation of the pivot.

19. The bathing construction of claim 16, further comprising at least one control unit communicatively coupled to the actuation system, wherein the at least one control unit is configured to control the movement of the seat.

20. The bathing construction of claim 19, wherein at least one of the at least one control unit is manually operable.

21. The bathing construction of claim 20, wherein at least one of the at least one control unit is arranged on the seat and is manually operable by a person sitting on the seat.

22. The bathing construction of claim 16, wherein the seat comprises at least one armrest arranged in a first horizontal direction, wherein at least one of the at least one armrest is movable between the first horizontal direction and a second direction different from the first horizontal direction.

23. The bathing construction of claim 16, wherein the seat comprises at least one weight sensor for sensing the weight of a person sitting on the seat.

24. The bathing construction of claim 23, wherein the at least one weight sensor is communicatively coupled to the actuation system, and wherein the actuation system is configured to move the seat as a function of the weight of a person sitting on the seat.

25. The bathing construction of claim 16, wherein the seat is removably fastened to the bathing construction for an exchange of the seat.

26. A bathing arrangement, comprising
a bathing construction as claimed in claim 16, and
a water supply system for a supply of water to the bathing enclosure.

27. The bathing arrangement of claim 26, comprising a product supply system for a supply of at least one body cleaning product to the bathing enclosure.

28. The bathing arrangement of claim 26, wherein the bathing arrangement comprises at least one nozzle arranged within the bathing enclosure for the purpose of cleaning a person sitting on the seat of the bathing construction.

29. A bathing system, comprising
a bathing arrangement of claim 27, and
a control system communicatively coupled to the water supply system and to the product supply system, wherein the control system is configured to control the supply of water and body cleaning product to the bathing enclosure.
